(19) United States
(12) Patent Application Publication
(10) Pub. No.: US 2011/0231256 A1
(43) Pub. Date: Sep. 22, 2011

(54) AUTOMATED BUILDING OF A MODEL FOR BEHAVIORAL TARGETING

(75) Inventors: Wu Wang, Los Altos, CA (US); Mei Marker, Santa Clara, CA (US); Kun Lu, San Jose, CA (US); Haijun Cao, Belmont, CA (US); Hong Yao, Newark, CA (US); Wei Wang, Milpitas, CA (US)

(73) Assignee: KINDSIGHT, INC., Sunnyvale, CA (US)

(21) Appl. No.: 12/842,934

(22) Filed: Jul. 23, 2010

Related U.S. Application Data
(60) Provisional application No. 61/228,551, filed on Jul. 25, 2009.

(51) Int. Cl. G06Q 30/00

(52) U.S. Cl. 705/14.53

(57) ABSTRACT

A method for generating a behavioral model for a targeted advertisement category (TAC), including: obtaining click stream data including ad-clicks and events preceding the ad-clicks and performed on web pages; assigning features having categories and keywords associated with the web pages to the events; identifying an ad-click of the ad-clicks and a subset of the events preceding the ad-click that result in the ad-click, where the subset of the events is associated with at least one feature; generating an aggregated event sequence by aggregating the ad-click and the subset of the events; selecting, in response to the at least one feature being associated with the TAC, a training data set including at least the aggregated event sequence; generating the behavioral model for the TAC by applying a learning algorithm to a portion of the training data set; and evaluating performance of built models and select model based on performance result.

### CROSS-REFERENCE TO RELATED APPLICATION

This application claims priority, pursuant to 35 U.S.C. §119(e), to the filing date of U.S. Provisional Patent Application Ser. No. 61/228,551, entitled “Automated Building of a Model For Behavioral Targeting,” filed on Jul. 25, 2009, which is hereby incorporated by reference in its entirety.

### BACKGROUND

A behavioral targeting modeling platform is a computer system that takes as input a set of historic behavioral data and generates as output a behavioral model. The modeling process includes a learning function that maps data into several predefined classes (e.g., categories). For behavioral targeting (e.g., targeting advertisements to Internet users), the model is typically derived from the analysis of a set of users' activities (i.e., behaviors) such as, but not limited to, searching, page viewing, ad clicking in a specific domain (e.g., the Internet).

Typically, to build behavioral models, several separate data processes are applied. The separate processes may have lengthy processing time cycles and may be error prone. Further, the separate processes may be difficult to scale up (i.e., increase throughput) and labor intensive because input of data mining experts may be required to integrate the data processes when building a model.

### SUMMARY

In general, in one aspect, the invention relates to a method for generating a behavioral model for a targeted advertisement category. The method comprises: obtaining click stream data comprising a plurality of ad-clicks and a plurality of events preceding the plurality of ad-clicks and performed on a plurality of web pages by a plurality of users; assigning a plurality of features comprising a plurality of categories and a plurality of keywords associated with the plurality of web pages to the plurality of events; identifying an ad-click of the plurality of ad-clicks and a subset of the plurality of events preceding the ad-click that result in the ad-click, wherein the subset of the plurality of events is associated with at least one feature of the plurality of features; generating an aggregated event sequence by aggregating the ad-click and the subset of the plurality of events; selecting, in response to the at least one feature being associated with the targeted advertisement category, a training data set comprising at least the aggregated event sequence; and generating the behavioral model for the targeted advertisement category by applying a learning algorithm to a first portion of the training data set.

In general, in one aspect, the invention relates to a system for generating a behavioral model. The system comprises: a memory; and a processor operatively connected to the memory and having functionality to execute instructions for: obtaining click stream data comprising a plurality of ad-clicks and a plurality of events preceding the plurality of ad-clicks and performed on a plurality of web pages by a plurality of users; assigning a plurality of features comprising a plurality of categories and a plurality of keywords associated with the plurality of web pages to the plurality of events; identifying an ad-click of the plurality of ad-clicks and a subset of the plurality of events preceding the ad-click that result in the ad-click, wherein the subset of the plurality of events is associated with at least one feature of the plurality of features; generating an aggregated event sequence by aggregating the ad-click and the subset of the plurality of events; selecting, in response to the at least one feature being associated with the targeted advertisement category, a training data set comprising at least the aggregated event sequence; and generating the behavioral model for the targeted advertisement category by applying a learning algorithm to a first portion of the training data set.

In general, in one aspect, the invention relates to a computer readable medium storing instructions for generating a behavioral model. The instructions when executed causing a processor to: obtain click stream data comprising a plurality of ad-clicks and a plurality of events preceding the plurality of ad-clicks and performed on a plurality of web pages by a plurality of users; assign a plurality of features comprising a plurality of categories and a plurality of keywords associated with the plurality of web pages to the plurality of events; identify an ad-click of the plurality of ad-clicks and a subset of the plurality of events occurring during a predetermined time period preceding the ad-click that result in the ad-click, wherein the subset of the plurality of events is associated with at least one feature of the plurality of features; generate an aggregated event sequence by aggregating the ad-click and the subset of the plurality of events; select, in response to the at least one feature being associated with the targeted advertisement category; and generate the behavioral model for the targeted advertisement category by applying a learning algorithm to a first portion of the training data set.

Other aspects of the invention will be apparent from the following description and the appended claims.

### BRIEF DESCRIPTION OF DRAWINGS

FIG. 1 shows a diagram of a system in accordance with one or more embodiments of the invention.

FIG. 2 shows a flowchart of a method in accordance with one or more embodiments of the invention.

FIG. 3 shows an example in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicated the description.

In general, embodiments of the invention provide a system and method for generating a behavioral model for analysis of a set of users' activities (i.e., behaviors) such as, but not limited to, searching, page viewing, ad clicking in a specific domain (e.g., the Internet). Specifically, in one or more embodiments of the invention, the method obtains and processes click stream data to generate the behavioral model. The click stream data may include events for users of web pages (e.g., ad clicks, page navigation, etc.). In this case, the click stream data may be transformed to a consistent format and then preprocessed to determine features for the click stream data. Features may include key words and categories related to the web content of the web pages. For example, a web page for selling automobiles may be associated with categories such as auto shopping, auto types/sedan etc. and with key words such as two-door, all-wheel drive, mpg, etc. In this example, the events of a user may involve interacting with a search engine for purchasing a car by inputting car related search terms or visiting car related web pages, where a car related ad is then clicked. At this stage, the method may collect all users' online behavior events as the click stream data, which is processed as training data for generating a behavioral model. A portion of the training dataset may also be used to evaluate the accuracy of the behavioral model. In one or more embodiments of the invention, the behavioral model may be used to predict user's click interest on a web page, for example, to ensure that the advertisements displayed on the web page are optimized to increase the probability of ad click through rate by users of the web page.

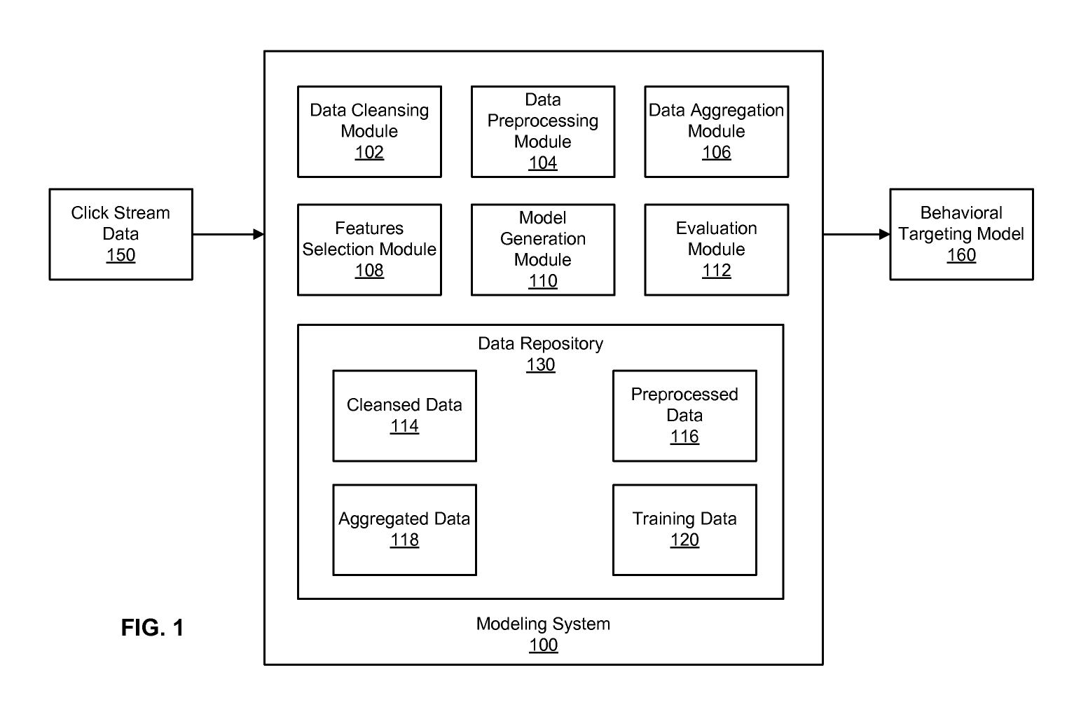

FIG. 1 shows a diagram of a system in accordance with one or more embodiments of the invention. The system includes Click Stream Data (150) interacting with a Modeling System (100). The Modeling System (100) further includes a Data Cleansing Module (102), a Data Preprocessing Module (104), a Data Aggregation Module (106), a Feature Selection Module (108), a Model Generation Module (110), a Model Evaluation Module (112), and a Data Repository (130). The Data Repository (130) further includes Cleansed Data (114), Preprocessed Data (116), Aggregated Data (118), and Training Data (120). The Modeling System (100) also interacts with a Behavioral Model (160). Each of the aforementioned components of FIG. 1 is discussed below.

In one or more embodiments of the invention, the Modeling System (100) is configured to obtain Click Stream Data (150), which includes a representation of users' Internet activities (i.e. behaviors). Examples of Internet activities include, but are not limited to, web page views, web ad clicks, web searches, etc. In one or more embodiments of the invention, the Click Stream Data (150) may be obtained from multiple web pages served on a number of web servers. For example, an internet service provider (“ISP”) may collect their subscribers' web traffic as click stream data. In other embodiments, the Click Stream Data (150) may be obtained from a data server configured to consolidate Click Stream Data (150) for multiple web pages.

In one or more embodiments of the invention, the Modeling System (100) may be configured to generate a Behavioral Model (160), which may be used, for example, in other systems and methods for behavioral targeting of advertisements to Internet users. While the present invention is described as generating a single Behavioral Model (160) for clarity and simplicity, the system and method of the present invention may be used to generate any number of behavioral models.

The Data Cleansing Module (102) is configured to transform the Click Stream Data (150) to a consistent data format. More specifically, the Click Stream Data (150) may be verified for accuracy and consistency, and the Data Cleansing Module (102) may either correct or remove irrelevant data (i.e. unnecessary) and incomplete, incorrect or inaccurate data for model generation, where the Click Stream Data (150) is then transformed into a consistent format (i.e. data representation). The cleansed data may be stored in the Data Repository (130) as Cleansed Data (114).

The Data Repository (130) may be any device capable of storing data (e.g., a computer system, a server, a hard drive, memory, a flash drive, etc). The Data Repository (130) may store software applications, code files, and/or any other data related to behavioral models. The Data Repository (130) is operatively connected to the Modeling System (100). In one or more embodiments of the invention, instructions related to the Modeling System (100) may be stored in the Data Repository (130). Alternatively, the instructions related to the Modeling System (100) may be stored on a different data storage device.

Those skilled in the art will appreciate that there is typically a huge quantity of Click Stream Data (150) to be processed. In this case, the Data Cleansing Module (102) may be configured to process the Click Stream Data (150) as a distributed application. For example, a software framework such as HADOOP™ may be used to distribute the Click Stream Data (150) to different nodes of the Data Cleansing Module (102) for processing. HADOOP™ is a trademark of Apache Software Foundation located in Forest Mill, Md. In this example, once the Click Stream Data (150) is processed by the Data Cleansing Module (102), the processed data may be consolidated when stored as Cleansed Data (114).

In one or more embodiments of the invention, the Data Preprocessing Module (104) is configured to associate one or more features with each activity (i.e., event) in the Cleansed Data (114). For example, a uniform resource locator (URL) associated with each activity (e.g., a web page address) may be used to crawl and tokenize the content at the URL to generate a set of corresponding features (i.e., a feature vector). In this example, the feature vector may then be retrieved from the Data Repository (130) based on the URL. Examples of features may include, but are not limited to, categories and key words for page view events, categories and advertising terms (i.e., ad-terms) for ad click events, and search terms for search events. Further, the Data Preprocessing Module (104) may be configured to store the preprocessed data in the Data Repository (130) as Preprocessed Data (116).

In one or more embodiments of the invention, the Data Aggregation Module (106) is configured to analyze the Preprocessed Data (116) to identify activities (i.e., events) that result in advertisement clicks (i.e., ad clicks). The Data Aggregation Module (106) may then aggregate the events that resulted in each of the advertisement clicks. In one or more embodiments of the invention, the Preprocessed Data (116) may be aggregated within a time window (e.g., hour, day, week, etc.) to quantify the intensity and duration of the events. The aggregated data includes all potential features used to generate training data. The Data Aggregation Module (106) may be configured to store the Aggregated Data (118) in the Data Repository (130).

In one or more embodiments of the invention, the Feature Selection Module (108) is configured to select a subset of features stored in the Aggregated Data (118) to use as Training Data (120). The selection of the Training Data (120) may be based on one or more features that are more important or contribute to (i.e., corresponding to) a targeted advertisement category. In this case, the Aggregated Data (118) that includes the associated features is included in the Training Data (120). The Feature Selection module (108) may be configured to store the Training Data (120) in the Data Repository (130).

In one or more embodiments of the invention, the Model Generation Module (110) is configured to generate a Behavioral Model (160) using the Training Data (120). More specifically, the Model Generation Module (110) may be configured to apply a learning algorithm (e.g., support vector machines (SVM), decision trees, naive Bayes classifier, neural networks and regression, etc.) to the Training Data (120) to generate the Behavioral Model (160).

In one or more embodiments of the invention, the Model Evaluation Module (112) is configured to use the portion of the training data not used by the Model Generation Module (110) to evaluate the performance of the Behavioral Targeting Model (160). For example, the evaluation of the model may be based on an F-measure (i.e., weighted harmonic mean of precision and recall) comparison. In this example, precision is a ratio of advertisement clicks that are correctly predicted by the Behavioral Targeting Model (160), and recall is the proportion of all actual advertisement clicks that were correctly identified by the Behavioral Targeting Model (160). For example, precision may be calculated as precision

$$= \frac{d}{b + d} ,$$

where d is the number of correct predictions of advertisement clicks and b is the number of incorrect predictions of advertisement clicks. In another example, recall may be calculated as recall

$$= \frac{d}{c + d} ,$$

where d is actual advertisement clicks that are predicted correctly and c is the number of actual advertisement clicks that are predicted wrongly. The F-measure may be calculated using the following equation:

$${F}_{β} = \frac{( 1 + {β}^{2} ) * ( precision * recall )}{( {β}^{2} * precision + recall )}$$

Where β is a weight of precision and recall. The F-measures calculated for different models (e.g., A and B) are compared and the model (e.g., A) with the greater value of F-measure may be preferred (i.e., deemed better) over the model (e.g., B) with the lesser F-measure. Those skilled in the art will appreciate that other equations (e.g., geometric means, etc.), parameters (e.g., accuracy, false positive rate, true negative rate, false negative rate, etc.) and other business decisions (e.g., high click through rate or low ad cost) may be used to evaluate the behavioral model.

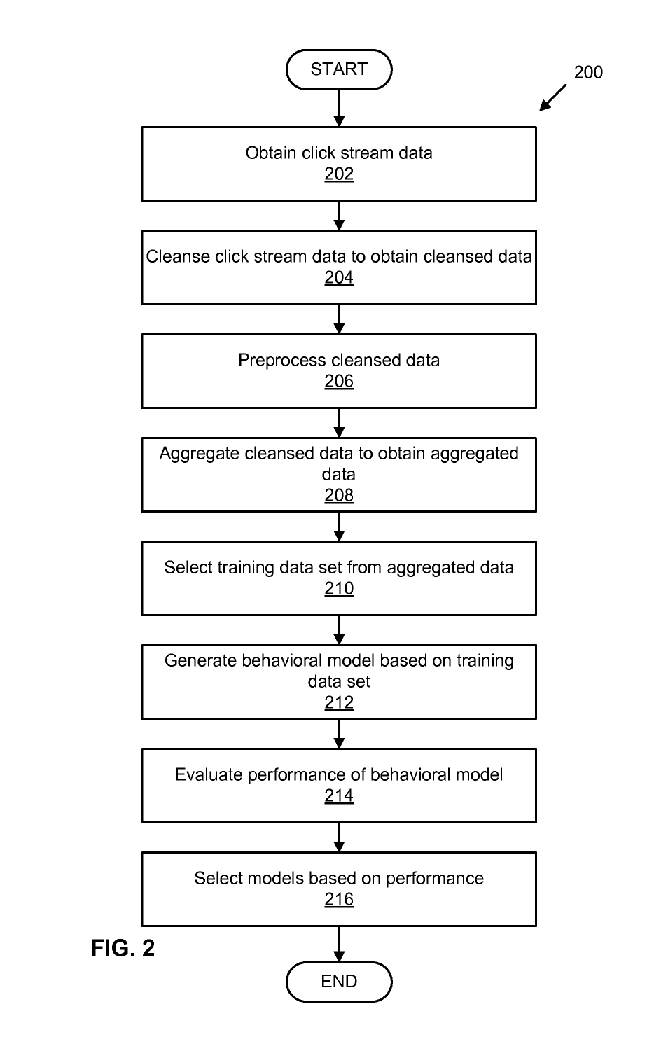

FIG. 2 shows a flowchart of a method for generating a behavioral model in accordance with one or more embodiments of the invention. The method of FIG. 2 may be implemented, for example, using the system of FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

In step 202, click stream data is obtained. As discussed above with respect to FIG. 1, click stream data may include Internet activities (i.e., events) for users of a number of web pages. The click stream data may be obtained from a variety of sources such as, but not limited to, logs of the web pages, monitoring applications running on the users' computers, a click stream data server configured to collect click stream data for the number of web pages, collected by an internet service provider (“ISP”) monitoring web traffic of the users, etc. Example click stream data is shown below in TABLE 1.

TABLE 1
Example Click Stream Data

| Timestamp | EVENT Type | URL/Search Term |
|---|---|---|
| 2010/06/01/20:00:00 | PV (page view) | www.search.com |
| 2010/06/01/20:01:02 | AC (ad click) | www.clothes.com |
| 2010/06/01/20:02:01 | SE (search terms) | cheapest tickets |
| . . . | . . . | . . . |
| . . . | . . . | |
| 2010/06/01/21:00:00 | PV | finance.search.com |
| 2010/06/01/21:02:01 | AC | http://www.flight.com/ |
| . . . | . . . | . . . |
| 2010/06/01/22:02:01 | SE | cheapest tickets |
| . . . | . . . | . . . |

In step 204, the click stream data is transformed to a consistent format (i.e., data representation). For example, the uniform resource locators (URL) in the click stream data may be modified to be all lower case. Further, any data that is irrelevant (i.e., unnecessary), incomplete, incorrect or inaccurate for the behavioral model may be either corrected or removed from the click stream data. For example, events with invalid event types may be removed, where valid event types include, but are not limited to, page view, ad click, search terms, etc. In another example, search terms that are not found in a stored vocabulary list are removed from the click stream data, URLs that are retrieved from a stored URL blacklist, or keywords include personal identity information (“PII”).

In step 206, the cleansed data is preprocessed to add (i.e., associate with) one or more features to each activity (i.e., event) in the cleansed data. A URL associated with each activity (e.g., a web page address) may be used to retrieve one or more corresponding features from a web-features repository, which are pre-determined by crawling the content of these webpage for a given URL, and then tokenizing the web content into a set of features. In this case, the web-features repository provides a mapping of a plurality of URLs to corresponding features. Examples of features may include, but are not limited to, categories and key words for page view events, categories and advertising terms (i.e., ad-terms) for ad click events, and search terms for search events. Example preprocessed data is shown below in TABLE 2.

TABLE 2
Example Preprocess Data

| | | | Key | | |
|---|---|---|---|---|---|
| Event | URL/search terms | Key word1 | word2 | . . . | category |
| PV | auto.yahoo.com | SUV | BMW | . . . | autos/retail/luxury |
| PV | . . . | . . . | . . . | . . . | . . . |
| AC | . . . | | | | |
| PV | . . . | | | | |
| SE | . . . | cheapest | tickets | | |
| . . . | . . . | | | | |
| PV | . . . | | | | |
| . . . | . . . | | | | |

In step 208, the preprocessed data is analyzed to identify activities (i.e., events) that result in ad clicks, where the events that result in each of the ad clicks are aggregated. In other words, the Internet activities of a user on a web page that result in an ad click may be aggregated. In one or more embodiments of the invention, the aggregation of the ad click and the Internet activities (i.e., events) that result in the ad click are referred to as an aggregated event sequence. For example, the aggregated result of a user's Internet activities within one hour may be aggregated. Within the one hour time window, the web pages visited may include three occurrences of the “luxury automobile” key word and two web pages that have automobile categories, which leads the user to click an automobile related advertisement.

In step 210, the aggregated data is analyzed to select a subset of data as training data. The selection of the training data may be based on one or more features associated with a targeted advertisement category. In this case, the targeted advertisement category may be compared to the features added in step 206 to identify the subset of data. The features that are irrelevant to a targeted advertisement category may be filtered. Aggregated data that includes the associated features may be included in the training data.

In step 212, a learning algorithm (e.g., support vector machines (SVM) decision trees, naive Bayes classifier, neural networks and regression, etc.) is applied to a portion (e.g., 80%) of the training data to generate a behavioral model.

In step 214, a remaining portion (e.g., 20%) of the training data not used in step 212 is used to evaluate the performance of the generated behavioral model. For example, the evaluation of the behavioral model may be based on, but not limited to, an F-measure (i.e., weighted harmonic mean of precision and recall) comparison as described above with respect to FIG. 1. In step 216, the F-measures calculated for different behavioral models may be compared to determine a preferred behavioral model with a greater value of F-measure. At this stage, the preferred behavioral model may be used to optimize ad clicks on the web page.

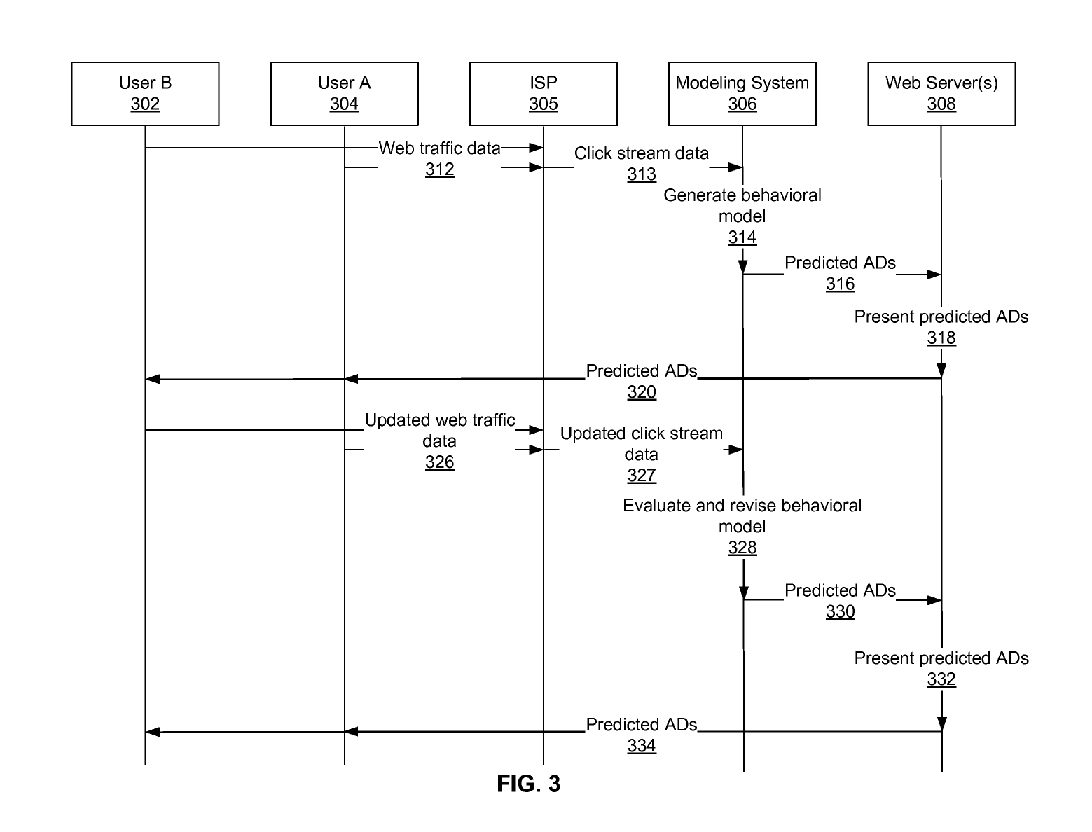

FIG. 3 shows a flow chart for generating behavioral models in accordance with one or more embodiments of the invention. In one or more embodiments of the invention, one or more of the steps shown in FIG. 3 may be omitted, repeated, and/or performed in a different order than that shown in FIG. 3. Accordingly, the specific arrangement of steps shown in FIG. 3 should not be construed as limiting the scope of the invention. Those skilled in the art will appreciate that the following example is provided for exemplary purposes only and accordingly should not be construed as limiting the scope of the invention.

In step 312, web traffic data of users such as User B (302) and User A (304) is collected by an internet service provider (“ISP”). For example, the ISP may monitor the web traffic of User B (302) and User A (304) with a number of web servers because User B (302) and User A (304) are subscribers of the ISP. In step 313, the web traffic data collected by ISP may be provided as click stream data to the Modeling System (306). Alternatively, the click stream data may be sent directly from the users (e.g., User B (302) and User A (304) to the Modeling System (306). In step 314, the Modeling System (306) may use the click stream data of these users to generate a behavioral model as discussed above with respect to FIG. 2.

In step 316, the behavioral model is used by the Modeling System (306) to predict the advertisements (“ADs”) that user may likely click and then deliver the predicted ADs to the user. Those skilled in the art will appreciate that the predicted ADs may specify an optimized set of advertisements that should be presented Web Server(s) (308) in order to increase click through rates. In step 318, the Web Server(s) (308) may present the optimized set of advertisements based on the predicted ADs. For example, the predicted ADs may specify that the number of automobile advertisements should be increased on the Web Server(s) (308) since the user are interesting auto related ADs.

In step 320, the predicted ADs are presented to User A (304) and User B (302). For example, the predicted ADs may appear as banner advertisements in web pages viewed by User A (304) and User B (302) or any other user having similar click stream patterns to User A (304) and User B (302).

In step 326, latest web traffic data may be obtained from User A (304) and User B (302) by the ISP (305). In step 327, the ISP may process the latest web traffic data to be provided as updated click stream data to the Modeling System (306). The updated click stream data includes Internet activities related to the updated web traffic data. In step 328, the behavioral model may be built, evaluated and revised by the Modeling System (306). For example, the updated click stream data may be used to build updated behavioral model and then determine F-Measure of the updated behavioral model, which is then compared to the original behavioral model. In this example, it may be determined that the revised behavioral model has improved F-Measure.

In step 330, the updated behavioral model is used by the Modeling System (306) to predict ADs that users are likely to click, which is provided to the Web Server(s) (308). At this stage, the Web Server(s) (308) may present a newly optimized set of advertisements based on the predicted ADs (step 332). In step 334, the newly optimized advertisements are presented to User A (304) and User B (302) or any other users having similar click-stream patterns to User A (304) and/or User B (302).

Those skilled in the art will appreciate that steps 326 to 334 may be repeated any number of times to further optimize the advertisements presented to the users. Since user's behavior may change over time, it is appreciated to generate new behavioral models to represent such behavior change. For example, the optimization process may be repeated based on a schedule (e.g., daily, weekly, monthly, etc.). In another example, the optimization process may be triggered when the click through rate of the advertisements falls below a specified threshold.

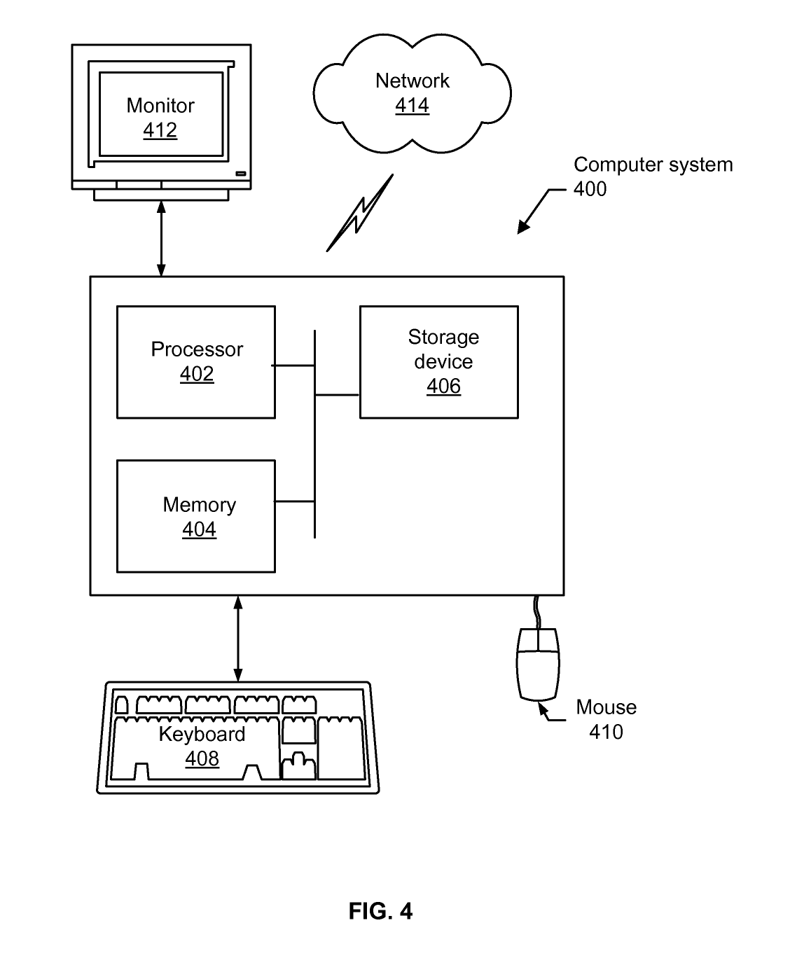

Embodiments of the invention may be implemented on virtually any type of computer regardless of the platform being used. For example, as shown in FIG. 4, a computer system (400) includes one or more processor(s) (402) such as a central processing unit (CPU) or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor (412) (e.g., a liquid crystal display (LCD), a plasma display, or cathode ray tube (CRT) monitor). The computer system (400) may be a desktop computer, a laptop computer, a personal media device, a mobile device, such as a cell phone or personal digital assistant, or any other computing system capable of executing computer readable instructions. The computer system (400) may be connected to a network (414) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms, now known or later developed. Generally speaking, the computer system (400) includes at least the minimal processing, input, and/or output means necessary to particularly practice embodiments of the invention.

Further, those skilled in the art will appreciate that one or more elements of the aforementioned computer system (400) may be located at a remote location and connected to the other elements over a network (414). Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a tangible computer readable storage medium such as a compact disc (CD), a diskette, a tape, a punch card, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a behavioral model for a targeted advertisement category comprising:
obtaining click stream data comprising a plurality of ad-clicks and a plurality of events preceding the plurality of ad-clicks and performed on a plurality of web pages by a plurality of users;
assigning a plurality of features comprising a plurality of categories and a plurality of keywords associated with the plurality of web pages to the plurality of events;
identifying an ad-click of the plurality of ad-clicks and a subset of the plurality of events preceding the ad-click that result in the ad-click, wherein the subset of the plurality of events is associated with at least one feature of the plurality of features;
generating an aggregated event sequence by aggregating the ad-click and the subset of the plurality of events;
selecting, in response to the at least one feature being associated with the targeted advertisement category, a training data set comprising at least the aggregated event sequence; and
generating the behavioral model for the targeted advertisement category by applying a learning algorithm to a first portion of the training data set.

2. The method of claim 1, wherein the subset of the plurality of events preceding the ad-click are identified based on a predetermined time period preceding the ad-click.

3. The method of claim 1, further comprising:
evaluating performance of the behavioral model using a second portion of the training data.

4. The method of claim 3, wherein the performance of the behavioral model is evaluated using the following equation:
$${F}_{β} = \frac{( 1 + {β}^{2} ) * ( precision * recall )}{( {β}^{2} * precision + recall )}$$
wherein F_{β} is a harmonic mean of precision and recall and β is a weight on the precision and the recall.

5. The method of claim 4, wherein:
precision is a ratio of advertisement clicks that are correctly predicted by the Behavioral Targeting Model, and recall is the proportion of all actual advertisement clicks that were correctly identified by the Behavioral Targeting Model.

6. The method of claim 1, further comprising:
mapping each of the plurality of features to a uniform resource locator of one of the plurality of web pages.

7. A system for generating a behavioral model comprising:
a memory; and
a processor operatively connected to the memory and having functionality to execute instructions for:
obtaining click stream data comprising a plurality of ad-clicks and a plurality of events preceding the plurality of ad-clicks and performed on a plurality of web pages by a plurality of users;
assigning a plurality of features comprising a plurality of categories and a plurality of keywords associated with the plurality of web pages to the plurality of events;
identifying an ad-click of the plurality of ad-clicks and a subset of the plurality of events preceding the ad-click that result in the ad-click, wherein the subset of the plurality of events is associated with at least one feature of the plurality of features;
generating an aggregated event sequence by aggregating the ad-click and the subset of the plurality of events;
selecting, in response to the at least one feature being associated with the targeted advertisement category, a training data set comprising at least the aggregated event sequence; and
generating the behavioral model for the targeted advertisement category by applying a learning algorithm to a first portion of the training data set.

8. The system of claim 7, wherein the subset of the plurality of events preceding the ad-click are identified based on a predetermined time period preceding the ad-click.

9. The system of claim 7, wherein the processor further has functionality to execute instructions for:
evaluating performance of the behavioral model using a second portion of the training data.

10. The system of claim 9, wherein the performance of the behavioral model is evaluated using the following equation:
$${F}_{β} = \frac{( 1 + {β}^{2} ) * ( precision * recall )}{( {β}^{2} * precision + recall )}$$
wherein F_{β} is a harmonic mean of precision and recall and β is a weight on the precision and the recall.

11. The system of claim 10, wherein:
precision is a ratio of advertisement clicks that are correctly predicted by the Behavioral Targeting Model, and recall is the proportion of all actual advertisement clicks that were correctly identified by the Behavioral Targeting Model.

12. The system of claim 7, wherein the processor further has functionality to execute instructions for:
mapping each of the plurality of features to a uniform resource locator of one of the plurality of web pages.

13. A computer readable storage medium storing instructions for generating a behavioral model, the instructions when executed causing a processor to:
obtain click stream data comprising a plurality of ad-clicks and a plurality of events preceding the plurality of ad-clicks and performed on a plurality of web pages by a plurality of users;
assign a plurality of features comprising a plurality of categories and a plurality of keywords associated with the plurality of web pages to the plurality of events;
identify an ad-click of the plurality of ad-clicks and a subset of the plurality of events occurring during a predetermined time period preceding the ad-click that result in the ad-click, wherein the subset of the plurality of events is associated with at least one feature of the plurality of features;
generate an aggregated event sequence by aggregating the ad-click and the subset of the plurality of events;
select, in response to the at least one feature being associated with the targeted advertisement category; and
generate the behavioral model for the targeted advertisement category by applying a learning algorithm to a first portion of the training data set.

14. The computer readable storage medium of claim 13, the instructions further comprising functionality to:
evaluate performance of the behavioral model using a second portion of the training data.

15. The computer readable storage medium of claim 14, wherein the performance of the behavioral model is evaluated using the following equation:
$${F}_{β} = \frac{( 1 + {β}^{2} ) * ( precision * recall )}{( {β}^{2} * precision + recall )}$$
wherein F_{β} is a harmonic mean of precision and recall and β is a weight on the precision and the recall.

16. The computer readable storage medium of claim 15, wherein:
precision is a ratio of advertisement clicks that are correctly predicted by the Behavioral Targeting Model, and recall is the proportion of all actual advertisement clicks that were correctly identified by the Behavioral Targeting Model.

17. The computer readable storage medium of claim 13, the instructions further comprising functionality to:
map each of the plurality of features to a uniform resource locator of one of the plurality of web pages.

18. The computer readable storage medium of claim 13, wherein the subset of the plurality of events preceding the ad-click are identified based on a predetermined time period preceding the ad-click.

19. The computer readable storage medium of claim 13, wherein the learning algorithm is a naïve Bayes classifier.

20. The computer readable storage medium of claim 13, wherein the learning algorithm is a neural network.
